(19) United States
(12) Patent Application Publication
(10) Pub. No.: US 2006/0217182 A1
(43) Pub. Date: Sep. 28, 2006

(54) Gaming machine

(75) Inventor: Yuichiro Suzuki, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Aruze Corp., Tokyo (JP)

(21) Appl. No.: 11/391,678

(22) Filed: Mar. 29, 2006

(30) Foreign Application Priority Data
Aug. 4, 2004 (JP) 2004-114709

(51) Int. Cl. A63F 13/00

(52) U.S. Cl. 463/20

(57) ABSTRACT

A gaming machine according to the present invention comprises: reel rotation start control means for starting the rotation of plural reels based on the detection of a game start command signal; winning combination determination means for determining a winning combination from predetermined winning combinations based on the detection of the game start command signal; stop command means for outputting a stop command signal in accordance with player's operations; reel stop control means for stopping the rotation of the reels based on the detection of a stop command signal and on the determined winning combination; and game value provision means for providing a predetermined game value to the player when the plural reels are stopped in a predetermined manner by the stop control means. Herein, the reel rotation start control means and the winning combination determination means have different control means.

### CROSS-REFERENCE TO RELATED APPLICATIONS

This application relates to Japanese Application No. 2004-114709.

### BACKGROUND OF THE INVENTION

1. Field of the Invention

The present invention relates to a gaming machine.

2. Discussion of the Background

For example, a slot machine including stop buttons, which is a so-called pachi-slot machine, is provided with a variation display device including display windows at the front surface and plural mechanical rotation reels arranged for displaying plural symbols or an electrical variation display device for displaying symbols on reels on the screen thereof. In accordance with player's starting operations, control means drives the variation display device to rotate the respective reels and, consequently, the symbols are varyingly displayed. After a constant time period, the rotations of the respective reels are stopped in order, automatically or through player's stopping operations. At this time, if a certain combination of symbols on the respective reels (winning symbols) appears in the display windows, gaming media such as coins or medals are paid out and, thus, a profit is provided to the player.

Current mainstream machine models have plural types of winning states. Particularly, if a predetermined winning combination is established, this causes a gaming state which is more advantageous than normal states to be continued for a predetermined time period, in addition to paying out coins a single time. As such winning combinations, there are a winning combination which allows the player to play a predetermined number of games which provide a relatively large profit to the player (which is referred to as a “big bonus” and, hereinafter, abbreviated to as “BB”) and a winning combination which allows the player to play a predetermined number of games which provide a relatively small benefit to the player (which is referred to as a “regular bonus” and, hereinafter, abbreviated to as “RB”)

Further, in current mainstream machine models, in order to cause a predetermined combination of symbols to be arranged along a winning line which is made effective (hereinafter, referred to as “an effective line”) to establish winning for paying out coins, medals or the like, a winning combination should be won (hereinafter, referred to as “internal winning”) as a result of an internal lottery process (hereinafter, referred to as “internal lottery”) and further the player is required to perform stopping operations at such timing that a combination of symbols indicative of winning of the winning combination obtained from the internal winning (hereinafter, referred to as “internal winning combination”) is stopped along the effective line.

Namely, even in the event of internal winning, if the player performs the stopping operations at bad timing, the player can not establish winning. Namely, current mainstream gaming machines require players to have excellent techniques in terms of the timing of stopping operations (such gaming machines are significantly dependent on techniques such as “observation push”). As such gaming machines, there have been known gaming machines which drive reels with pulse motors (for example, refer to JP-B 3-72313).

In the aforementioned gaming machines, generally, the reels are driven through a stepping motor intervention process, and the reels are rotated at a constant speed of about 80 rpm. Since driving of the reels is controlled through this intervention process, it is necessary to perform a large acceleration at a final-stage acceleration (for example, acceleration from 40 rpm to 80 rpm) and, therefore, large-sized stepping motors capable of generating large torque are employed to drive the rotations of the reels.

However, in the aforementioned gaming machine, since a CPU output port directly controls respective layers of the stepping motor, capacity load of data and process for pulse sequence at the time of activation, during rotation, and at the time of deceleration (stoppage) is large. Therefore, an intervention timer period becomes dependent on the rotation speed of the motor.

The contents of Japanese Patent Application No. 2004-114709 and Japanese Kokoku Publication No. Hei-3-72313 (1991) are incorporated herein by reference in their entirety.

### SUMMARY OF THE INVENTION

It is an object of the present invention to provide a gaming machine capable of realizing load reduction of process conducted in CPU and the like.

The present invention has been made in view of the aforementioned problems and is characterized in that, in a gaming machine, reel rotation start control means and winning combination determination means have different control means.

More specifically, the present invention provides the following gaming machine.

(1) A gaming machine comprising: game start command means for outputting a game start command signal for commanding the start of an unit game in accordance with player's operations; reel rotation start control means for starting the rotation of plural reels based on the detection of the game start command signal; winning combination determination means for determining a winning combination from predetermined winning combinations based on the detection of the game start command signal; stop command means for outputting a stop command signal in accordance with player's operations; reel stop control means for stopping the rotation of the reels based on the detection of the stop command signal and on the determined winning combination; and game value provision means for providing a predetermined game value to the player when the plural reels are stopped in a predetermined manner by the stop control means, wherein the reel rotation start control means and the winning combination determination means have different control means.

With the present invention, it is possible to provide a gaming machine capable of realizing load reduction of process conducted in CPU and the like.

### BRIEF DESCRIPTION OF THE DRAWINGS

FIG. 1 is a perspective view of a gaming machine according to the present embodiment;

FIG. 2 is a block diagram illustrating the structure of the electric circuit according to the present embodiment;

FIG. 3 is a view illustrating exemplary symbols arranged on reels;

FIG. 4 is a view illustrating a reel unit;

FIG. 5 is a view illustrating the relationship between symbols and motor phases;

FIGS. 6A and 6B are views illustrating the change of the reel rotation speed;

FIGS. 7A and 7B are views illustrating various types of control tables;

FIG. 8 is a flowchart illustrating a RESET intervention process;

FIG. 9 is a flowchart subsequent to FIG. 8;

FIG. 10 is a flowchart subsequent to FIG. 9;

FIG. 11 is a flowchart illustrating a gaming status supervisory process;

FIG. 12 is a flowchart illustrating a periodic intervention process;

FIG. 13 is a flowchart illustrating a reel controlling process;

FIG. 14 is a flowchart illustrating a stop controlling process;

FIG. 15 is a flowchart illustrating an acceleration controlling process;

FIG. 16 is a flowchart illustrating a rotation starting process;

FIG. 17 is a flowchart illustrating a constant speed controlling process;

FIG. 18 is a flowchart illustrating a pulse counter updating process;

FIG. 19 is a flowchart illustrating a pulse counter updating sub;

FIG. 20 is a flowchart illustrating a pulse outputting process; and

FIG. 21 is a flowchart illustrating an acceleration timer setting process.

### DESCRIPTION OF THE EMBODIMENTS

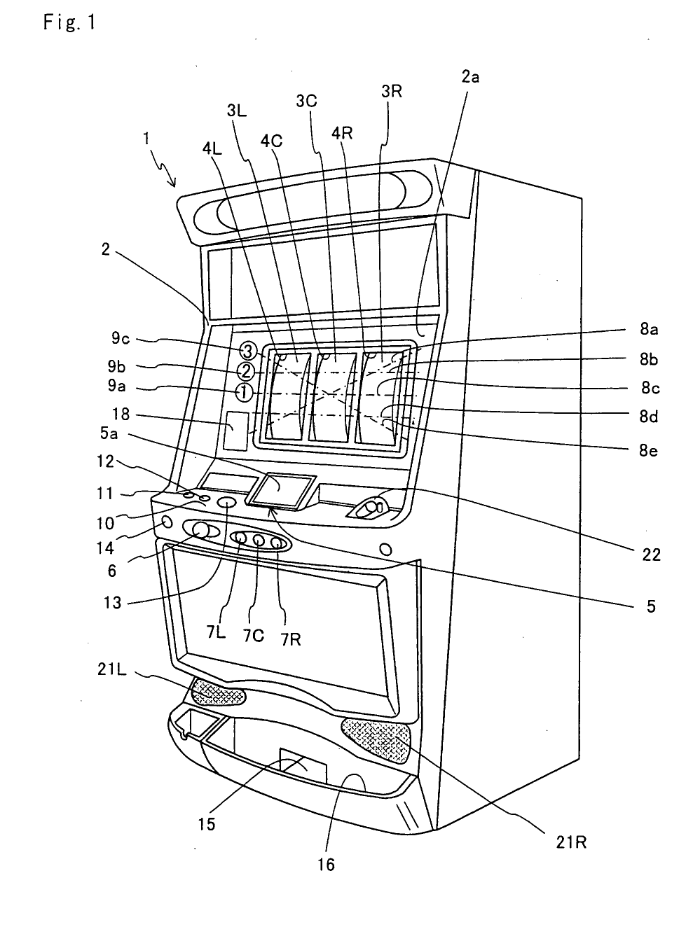

FIG. 1 is a perspective view illustrating the external view of a gaming machine 1 according to an embodiment of the present invention. The gaming machine 1 is a so-called pachi-slot machine. The gaming machine 1 is a gaming machine which enables playing games by using gaming media such as a card, storing information about a game value which is provided to a player or is to be provided to the player, as well as coins, medals, game balls or tokens. Hereinafter, the gaming machine 1 will be described as a gaming machine which enables using medals.

At the front surface of a cabinet 2 forming the entire gaming machine 1, there is formed a panel display portion 2a having a substantially vertical surface, and there are also provided vertically longer rectangular display windows 4L, 4C and 4R, at the center thereof. On the display windows 4L, 4C and 4R, there are provided a horizontal top line 8b, a center line 8c, a bottom line 8d, a diagonal cross-up line 8a and a diagonal cross-down line 8e, as winning lines.

Out of these winning lines, a single line, three lines or five lines are made effective by operating a 1-BET switch 11, a 2-BET switch 12 or a maximum-BET switch 13, which will be described later, or by inserting medals into a medal insertion slot 22. The winning lines which are made effective are indicated by lighting BET lamps 9a, 9b and 9c, which will be described later.

Within the cabinet 2, three reels 3L, 3C and 3R are provided rotatably and laterally in a row, wherein each of the reels has a row of symbols which is drawn on its outer peripheral surface and is constituted by plural types of symbols. These reels form variation display means. The symbols on the respective reels can be observed through the display windows 4L, 4C and 4R. The respective reels are rotated at a constant rotation speed (for example, 80 rpm).

At the left of the display windows 4L, 4C and 4R, there are provided the 1-BET lamp 9a, the 2-BET lamp 9b, the maximum-BET lamp 9c and an information display portion 18. The 1-BET lamp 9a, the 2-BET lamp 9b and the maximum-BET lamp 9c are lighted in accordance with the number of medals bet for playing a single game (hereinafter, referred to as “the number of BETs”.

The 1-BET lamp 9a is lighted when the number of BETs is 1 and a single winning line is made effective. The 2-BET lamp 9b is lighted when the number of BETs is 2 and three winning lines are made effective. The maximum-BET lamp 9c is lighted when the number of BETs is 3 and all the winning lines (the five winning lines) are made effective. The information display portion 18 is constituted by 7-segment LEDs and indicates the number of medals being stored (credited), the number of medals which will be paid out in the event of winning, and the number of games in a BB normal gaming state which will be described later.

Under the display windows 4L, 4C and 4R, there is formed a base portion 10 having a horizontal surface. A liquid crystal display device 5 is provided between the base portion 10 and the display windows 4L, 4C and 4R. Various types of effects are executed on a display screen 5a of the liquid crystal display device 5 to notify the player of information about games and the like, through effects. The medal insertion slot 22 is provided at the right of the liquid crystal display device 5, while the 1-BET switch 11, the 2-BET switch 12 and the maximum-BET switch 13 are provided at the left of the liquid crystal display device 5.

By pushing the 1-BET switch 11 a single time, a single medal, out of medals being credited, is bet on a game. By pushing the 2-BET switch 12 a single time, two medals, out of medals being credited, are bet on a game. The maximum-BET switch 13 enables betting a maximum number of medals which can be bet on a single game. As previously described, by operating these BET switches, predetermined winning lines can be made effective.

At a leftwardly-biased position on the front surface of the base portion 10, there is provided a C/P switch 14 which enables switching between crediting and paying-out of medals which the player acquired in games, by performing button-pushing operations thereon. By switching therebetween using the C/P switch 14, medals are paid out from a medal payout slot 15 at a lower portion of the front surface, and the paid-out medals are stored on a medal receiving portion 16. At the right of the C/P switch 14, a start lever 6 is mounted such that it is rotatable over a predetermined angle range. When the start lever 6 is operated by the player, the above-mentioned reels rotate, to start variation display of symbols within the display windows 4L, 4C and 4R.

On the front surface of the base portion 10, at the center portion thereof under the liquid crystal display device 5, there are provided three stop buttons (stopping operation means) 7L, 7C and 7R for stopping the rotations of the three reels 3L, 3C and 3R, respectively. Speakers 21L and 21R are provided at the left side and the right side above the medal receiving portion 16.

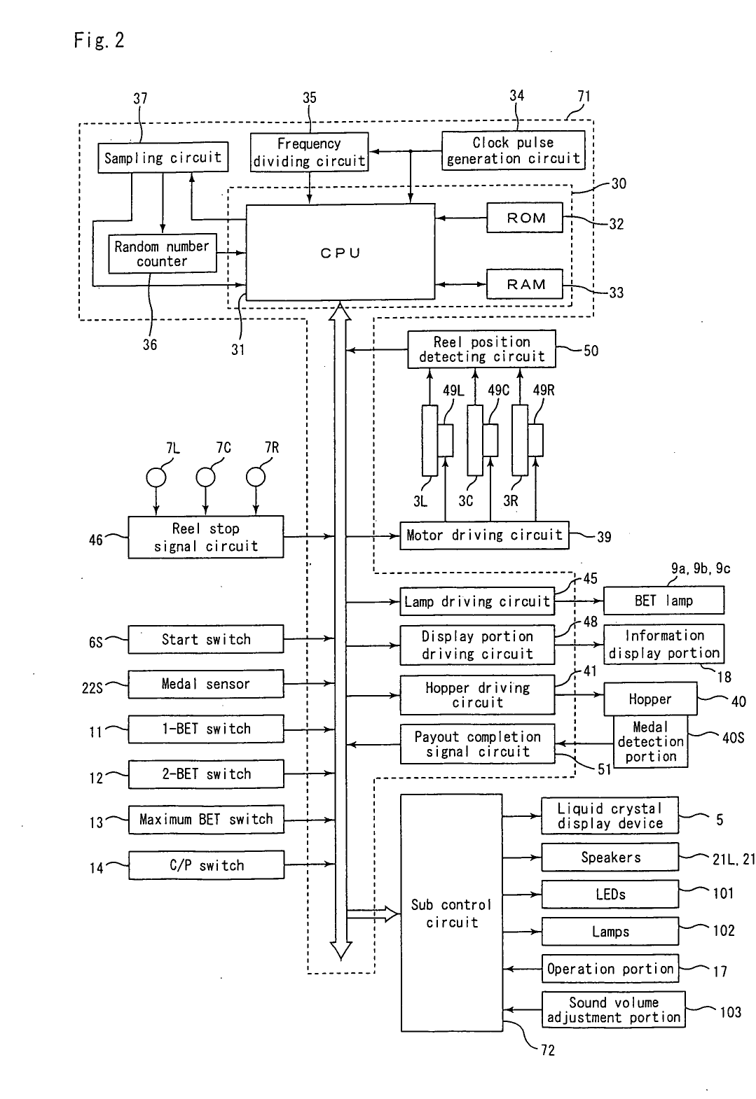

FIG. 2 illustrates a circuit structure including a main control circuit 71 for controlling the gaming processing operations in the gaming machine 1, peripheral devices (actuators) electrically connected to the main control circuit 71 and a sub control circuit 72 for controlling the liquid crystal display device 5, the speakers 21L and 21R, LEDs 101 and lamps 102, based on control commands transmitted from the main control circuit 71.

The main control circuit 71 is constituted by a microcomputer 30 as a main component which is placed on a circuit board together with circuits for random number sampling. The microcomputer 30 includes a CPU 31 for performing controlling operations according to preset programs and a ROM 32 and a RAM 33 which are storage means.

A clock pulse generation circuit 34 and a frequency dividing circuit 35 for generating reference clock pulses, and a random number counter 36 and a sampling circuit 37 for generating random numbers to be sampled are connected to the CPU 31. Also, as means for random number sampling, the microcomputer 30 may be structured to execute random number sampling therewithin, namely within operation programs executed by the CPU 31. In such a case, the random number counter 36 and the sampling circuit 37 may be omitted or may be left for backing up random number sampling operations.

The ROM 32 in the microcomputer 30 stores a probability sortition table for use in random number sampling determination performed every time the start lever 6 is operated (starting operation), a stop table used for determining the reel stopping state according to the operation of the stop buttons, various types of control commands (commands) to be transmitted to the sub control circuit 72, and various types of tables and the like. The sub control circuit 72 can not input commands, information and the like to the main control circuit 71, and communication only in a single direction from the main control circuit 71 to the sub control circuit 72 can be conducted. The RAM 33 stores various types of information such as flags, information about the gaming state and the like.

In the circuit of FIG. 2, as main actuators whose operations are under the control of control signals from the microcomputer 30, provided are BET lamps (the 1-BET lamp 9a, the 2-BET lamp 9b and the maximum-BET lamp 9c), the information display portion 18, a hopper (including a driving portion for paying out) 40 for storing medals and paying out a predetermined number of medals in response to commands from a hopper driving circuit 41, and stepping motors 49L, 49C and 49R for driving the rotations of the reels 3L, 3C and 3R.

Further, a motor driving circuit 39 for driving and controlling the stepping motors 49L, 49C and 49R, the hopper driving circuit 41 for driving and controlling the hopper (game value provision means) 40, a lamp driving circuit 45 for driving and controlling the BET lamps 9a, 9b and 9c and a display portion driving circuit 48 for driving and controlling the information display portion 18 are connected to the output portion of the CPU 31. Each of these driving circuits control the operations of the respective actuators in response to control signals such as driving commands output from the CPU 31.

For example, the motor driving circuit 39 outputs excitation signals to the stepping motors 49L, 49C and 49R (the motor driving circuit 39 drives the stepping motors with magnetic forces), based on an output pulse data output from the CPU 31. Further, the motor driving circuit 39 is provided separately from the main control circuit 71, includes a dedicated LSI for controlling the motors and is capable of controlling the sequence, the pulse period and the like, in a hardware manner. Therefore, processing with the CPU 31 may be limited to only “start of rotation”, “request for stop” and “detection of positions”.

Further, a start switch 6S, the 1-BET switch 11, the 2-BET switch 12, the maximum-BET switch 13, the C/P switch 14, a medal sensor 22S, a reel stop signal circuit 46, a reel position detecting circuit 50 and a payout completion signal circuit 51 are provided as main input signal generation means which generate input signals required to cause the microcomputer 30 to generate control commands.

The start switch 6S detects the operation of the start lever 6. The medal sensor 22S detects medals inserted into the medal insertion slot 22. The reel stop signal circuit 46 generates stop signals in accordance with the operations of the respective stop buttons 7L, 7C and 7R. The reel position detecting circuit 50 sends, to the CPU 31, signals for detecting the positions of the respective reels 3L, 3C and 3R, on receiving pulse signals from reel rotation sensors. The payout completion signal circuit 51 generates signals for detecting the completion of payout of medals, when the count value of a medal detection portion 40S (the number of medals paid out from the hopper 40) reaches a value equal to a specified number-of medals data.

In the circuit of FIG. 2, the value of the random number counter 36 is updated by incrementing the value by one at 0.25-msec intervals. The sampling circuit 37 samples a single random number at proper timing within a constant speed rotation attaining time. On the basis of the sampled random number and the probability sortition table stored in the ROM 32, a winning combination is determined (hereinafter, the winning combination thus determined is also referred to as “determined winning combination”).

After the rotations of the reels 3L, 3C and 3R are started, the number of driving pulses supplied to the respective stepping motors 49L, 49C and 49R are counted, and the counted numbers are written in a predetermined area of the RAM 33. Reset pulses are generated (so-called indexes are detected) from the respective reels 3L, 3C and 3R every time they have completed a single rotation, and these pulses are input to the CPU 31 through the reel position detecting circuit 50.

Based on the reset pulses thus generated, the respective driving pulse count values, which are counted within the RAM 33, are cleared to zero. Accordingly, the count values corresponding to the rotational positions of the respective reels 3L, 3C and 3R within a single rotation range are stored in the RAM 33.

The stepping motors 49L, 49C and 49R employ a two-layer excitation system. The excitation pattern is realized by predetermined pulse signals generated from the CPU 31. The pulse signals (pulse data) are input to the motor driving circuit 39, and the motor driving circuit 39 outputs excitation signals according to the pulse signals to the stepping motors 49L, 49C and 49R for driving them.

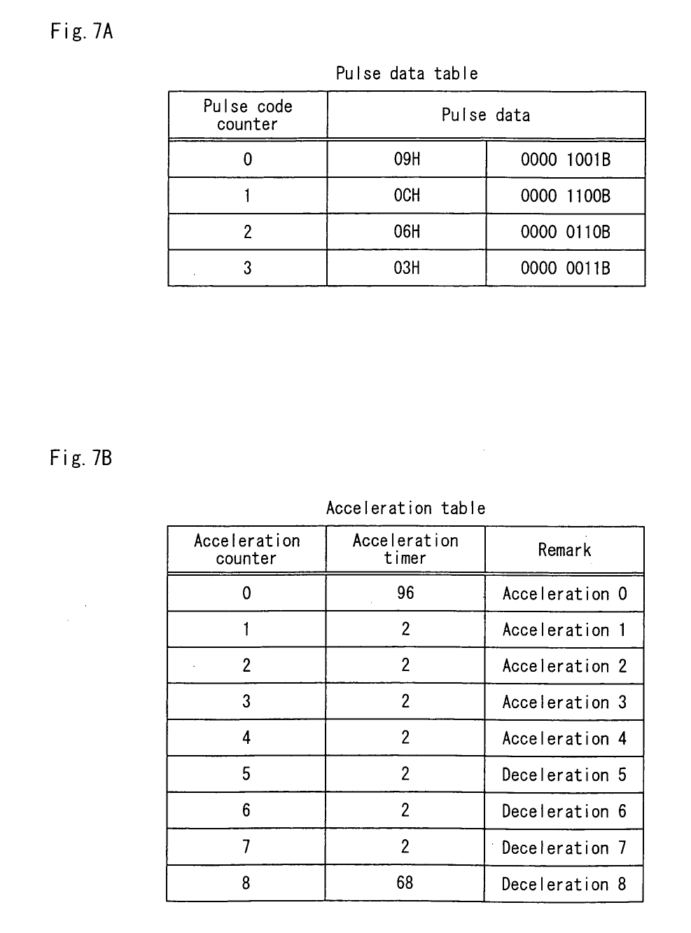

In the present embodiment, four pulse data 09 (H), 0C (H), 06(H) and 03(H) (FIG. 7A) is output in this order to rotate the reels 3L, 3C and 3R.

The pulse data control period (the period of intervention) is 2.2346 msec (a first period), after the reels 3L, 3C and 3R reach a constant speed rotation (during constant speed control). After their rotations are started and before they reach constant speed rotations (during acceleration control), the period is 4.4692 msec (a second period).

In order to associate the aforementioned rotational positions of the reels 3L, 3C and 3R with the symbols drawn on the reel outer peripheral surfaces, a symbol table (not shown) is stored in the ROM 32. In the symbol table, based on the rotational positions generated from the aforementioned reset pulses, code numbers sequentially attached to the respective reels 3L, 3C and 3R at respective constant rotation pitches are associated with symbol codes indicative of symbols provided in correspondence with the respective code numbers.

Further, the ROM 32 stores a winning symbol combination table (not shown). In the winning symbol combination table, winning symbol combinations, the numbers of medals to be paid in the event of winning, and winning determination codes indicative of winning are associated with one another. Reference is made to the aforementioned winning symbol combination table, in performing the stop control on the left reel 3L, the center reel 3C and the right reel 3R and in performing winning confirmation after all the reels 3L, 3C and 3R are stopped.

In the event that winning occurs as a result of a lottery process (probability sortition process) based on the aforementioned random number sampling, the CPU 31 sends, to the motor driving circuit 39, signals for performing stop control on the reels 3L, 3C and 3R, based on operation signals, which are transmitted from the reel stop signal circuit 46 at the timing when the player operates the stop buttons 7L, 7C and 7R, and on the selected stop table.

When the reels show a stopped manner in which the winning combination determined appears, the CPU 31 sends payout command signals to the hopper driving circuit 41 to cause the hopper 40 to pay out a predetermined number of medals. At this time, the medal detection portion 40S counts the number of medals paid out from the hopper 40 and, when the count value reaches a specified value, the medal detection portion 40S inputs a medal payout completion signal to the CPU 31. Thus, the CPU 31 stops the driving of the hopper 40 through the hopper driving circuit 41 to complete the medal payout process.

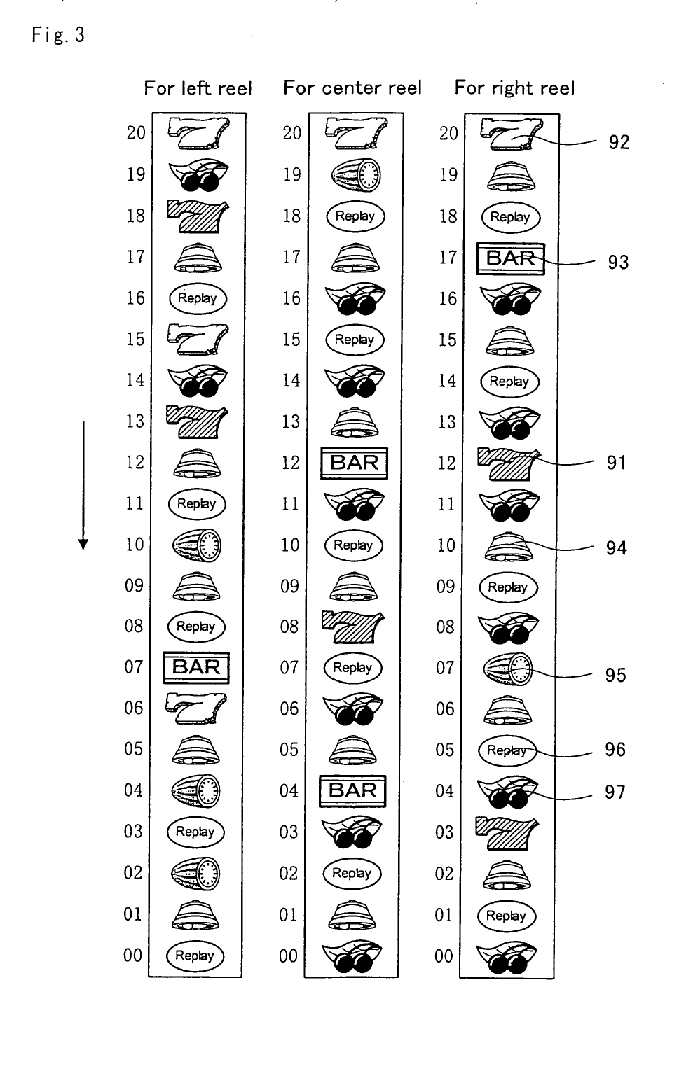

FIG. 3 illustrates the rows of symbols (the rows of symbols drawn on symbol sheets) consisting of plural types of symbols represented on the respective reels 3L, 3C and 3R, wherein 21 symbols are arranged in the respective rows.

Code numbers of 00 to 20 are attached to the respective symbols and are stored (recorded), as a data table, in the ROM 32 (FIG. 2) which will be described later. On the respective reels 3L, 3C and 3R, there are provided the rows of symbols consisting of a red-7 symbol (symbol 91), a white-7 symbol (symbol 92), a BAR symbol (symbol 93), a bell symbol (symbol 94), a watermelon symbol (symbol 95), a Replay symbol (symbol 96) and a cherry symbol (symbol 97). The respective reels 3L, 3C and 3R are driven to be rotated such that the rows of symbols are moved in the direction of an arrow shown in FIG. 3.

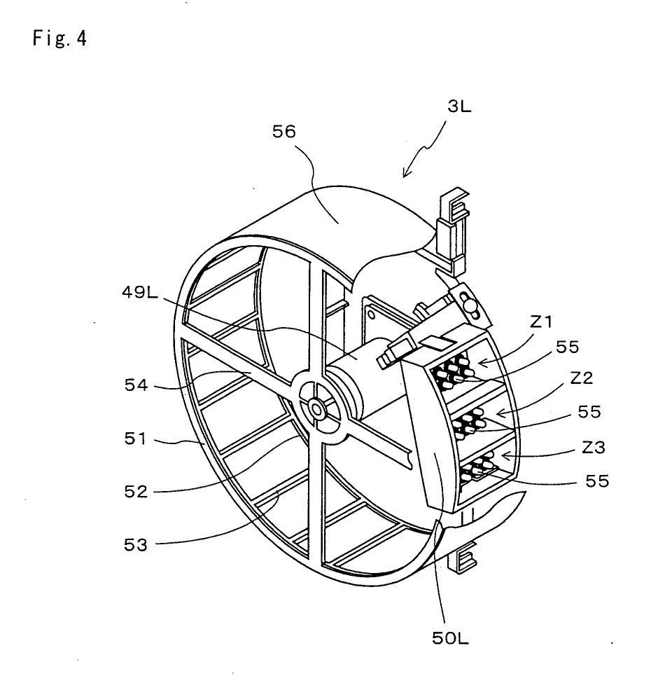

FIG. 4 illustrates one of the reels (3L), a lamp case SOL provided inside the reel 3L and the stepping motor 49L.

The reel 3L is constituted by a cylindrical frame construction made of two identically shaped annular frames 51 and 52 spaced apart from each other by a predetermined interval (the reel width) and plural coupling members 53 coupling the frames 51 and 52 to each other, and a transfer member 54 for transferring the driving force from the stepping motor 49L provided at the center portion of the frame construction to the annular frames 51 and 52.

A reel sheet 56, which is mounted along the outer peripheral surface of the reel 3L, is made of a semitransparent film member, and symbols are printed on the surface thereof with light permeability color inks. As for the region other than the symbols, masking treatment is applied thereto with a light shield ink.

The lamp case 50L placed within the reel 3L includes three rooms Z1, Z2 and Z3, each housing six three-colored LED lamps 55. The lamp case 50L is installed such that, when the rotation of the reel 3L is stopped, the three rooms Z1, Z2 and Z3 are positioned at the back side of a symbol (a total of three symbols) appearing within the display window 4L.

While the reels 3C and 3R are not illustrated, they have the same construction as that of the reel 3L and include a lamp case 50C and a lamp case 50R therein, respectively.

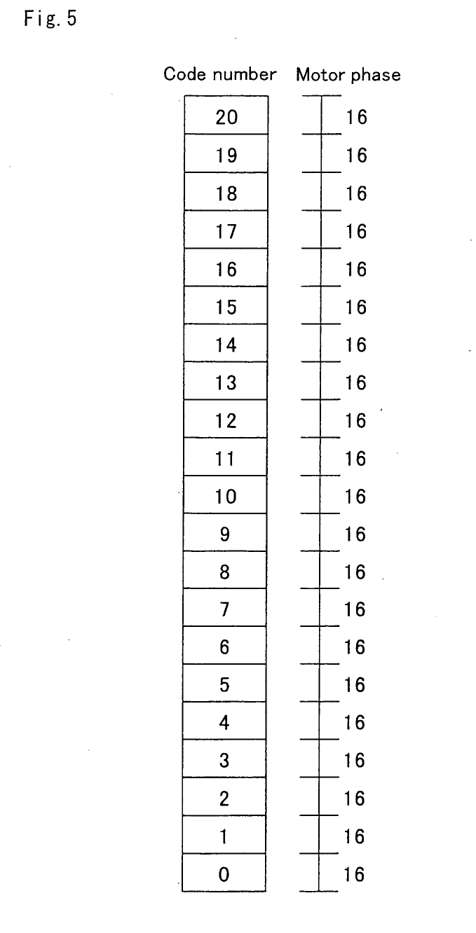

FIG. 5 illustrates phases assigned to the regions in which the respective symbols are represented. Sixteen phases are assigned to each symbol (the region corresponding to each symbol) (by outputting pulse data 16 times, the reel is rotated by an amount corresponding to a single symbol).

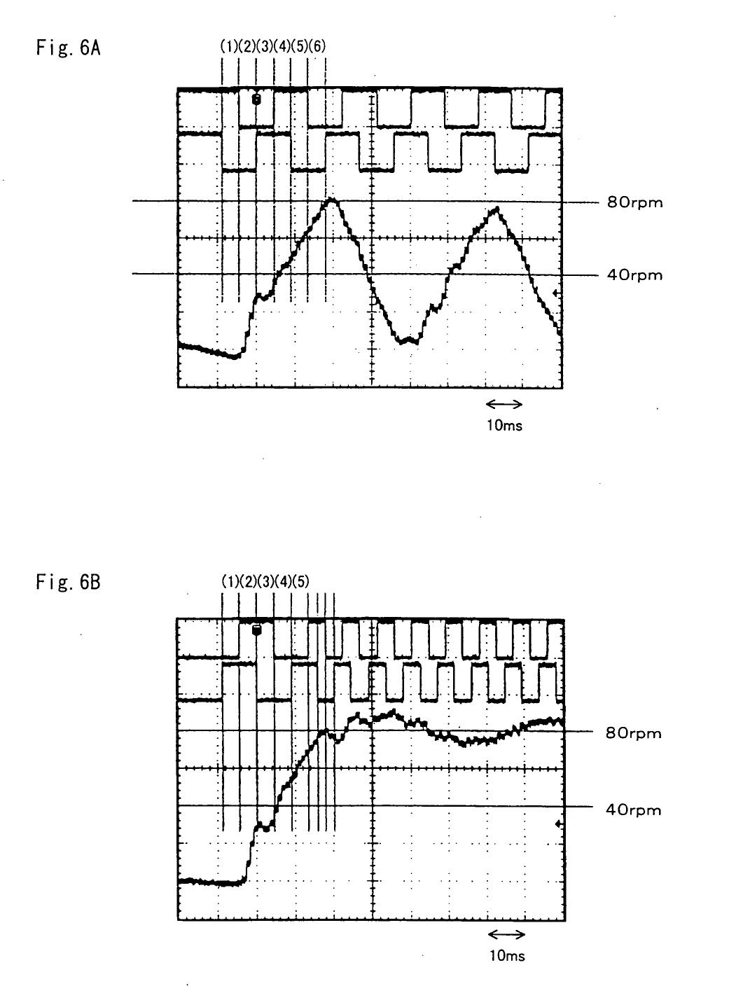

FIGS. 6A and 6B illustrate the change of the reel rotation speed, according to the pulse data (pulse signals) output period. The time intervals designated by (1) to (6) correspond to the output period of pulse data.

FIG. 6A illustrates the change of the reel rotation speed, in the case where the pulse data output period is set to 4.4692 msec. The rotation speed of the reels is oscillated due to the inertia, wherein the greatest rotation speed is about 80 rpm and the smallest rotation speed is about 20 rpm.

FIG. 6B illustrates the change of the reel rotation speed, in the case where the pulse data output period is set to 4.4692 msec during the acceleration control while the pulse data output period is set to 2.2346 msec (which is one-half of the output period during the acceleration control) during the constant speed control.

When the pulse data output period is set to 4.4692 msec, the reel rotation speed is increased due to the inertia. After the pulse corresponding to (5) is output, the pulse data output period is updated to 2.2346 msec and, thereafter, the reel rotation speed is maintained at about 80 rpm.

At this time, as illustrated in FIG. 6B, the mechanism and the acceleration profile are configured to make large oscillations occur in the rotation of reels and, at the time when the oscillation component in the direction of acceleration reaches around a peak, the frequency is switched to a next frequency (the driving frequency is aimed to be raised at the time when the oscillation component in the direction of acceleration reaches around a peak, while the oscillations during the activation is not suppressed). With this method, it is possible to overcome the limitation on the control which is imposed by the intervention process, even with a small motor capable of generating small torque. Further, the stepping motors 49L, 49C and 49R according to the embodiment have such a spec that they are not activated to 80 rpm after the oscillation is limited to 40 rpm.

FIGS. 7A and 7B illustrate tables (control information) stored in the main control circuit 71.

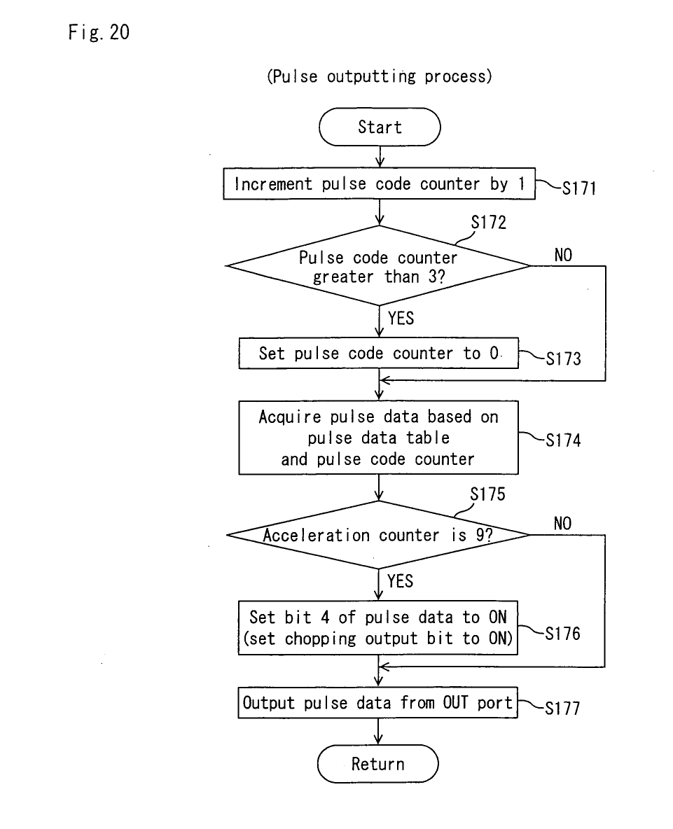

FIG. 7A illustrates a pulse data table. This table stores information on pulse data to be output according to the value of the pulse code counter and is used in step S174 in FIG. 20 which will be described later. The value of the pulse code counter is incremented by one each time a pulse outputting process (FIG. 20) which will be described later is conducted and is information used for identifying pulse data to be output.

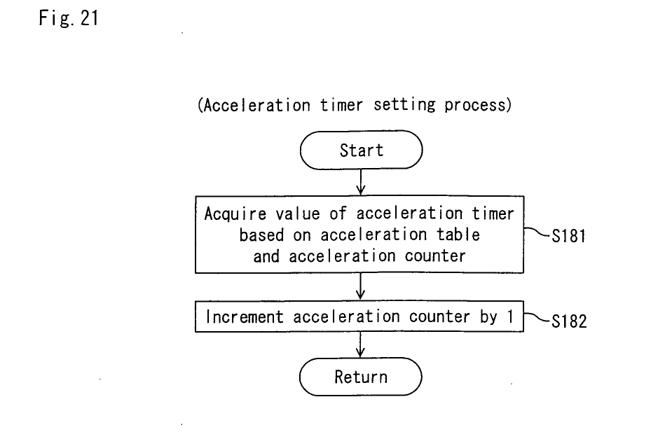

FIG. 7B illustrates an acceleration table. This table stores information about an acceleration timer which is set according to the value of the acceleration counter and, this table is used in step S181 in FIG. 21, which will be described later. The acceleration counter is information indicative of the progress (the control state) of the acceleration control or the stop control for the reels. The acceleration timer is a value which defines the pulse data output period during acceleration or deceleration of the reels.

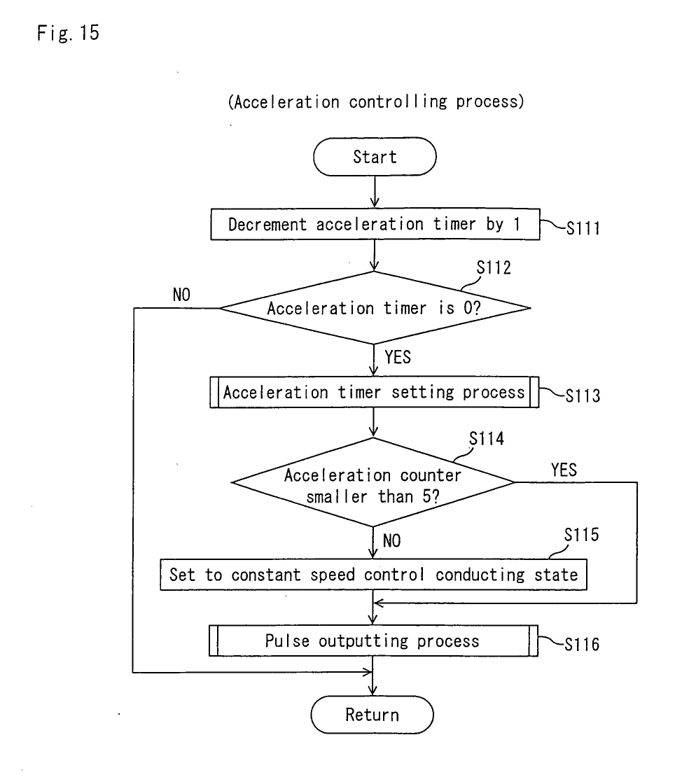

The value of the acceleration timer is acquired in accordance with the value of the acceleration counter and, after the acquiring process, the value of the acceleration counter is incremented by one (FIG. 21 which will be described later). When the value of the acceleration counter is updated to 5 or more, the control state is switched from the acceleration control conducting state to the constant speed control conducting state (FIG. 15 which will be described later).

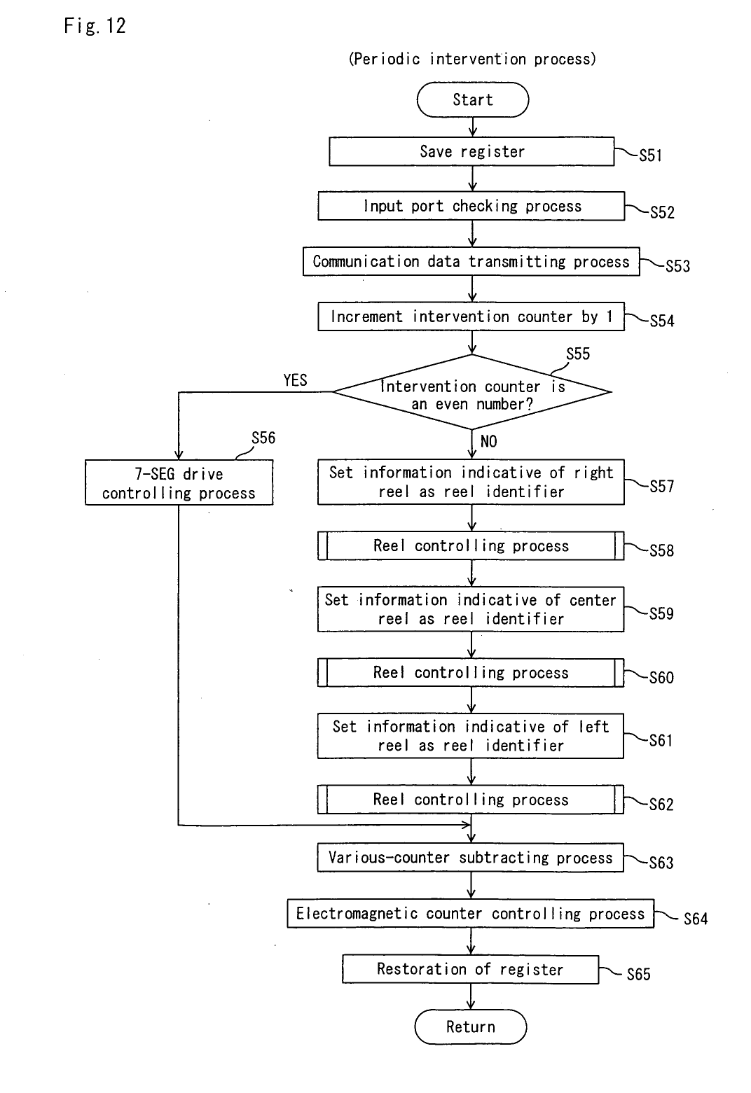

Since the acceleration timer is set to 2 in correspondence with the acceleration counter values of 1 to 4, the pulse data output period during the acceleration control is set to 4.4692 msec. Further, during the constant speed control, pulse data is output at a period at which the determination in step S55 in FIG. 12 which will be described later results in YES.

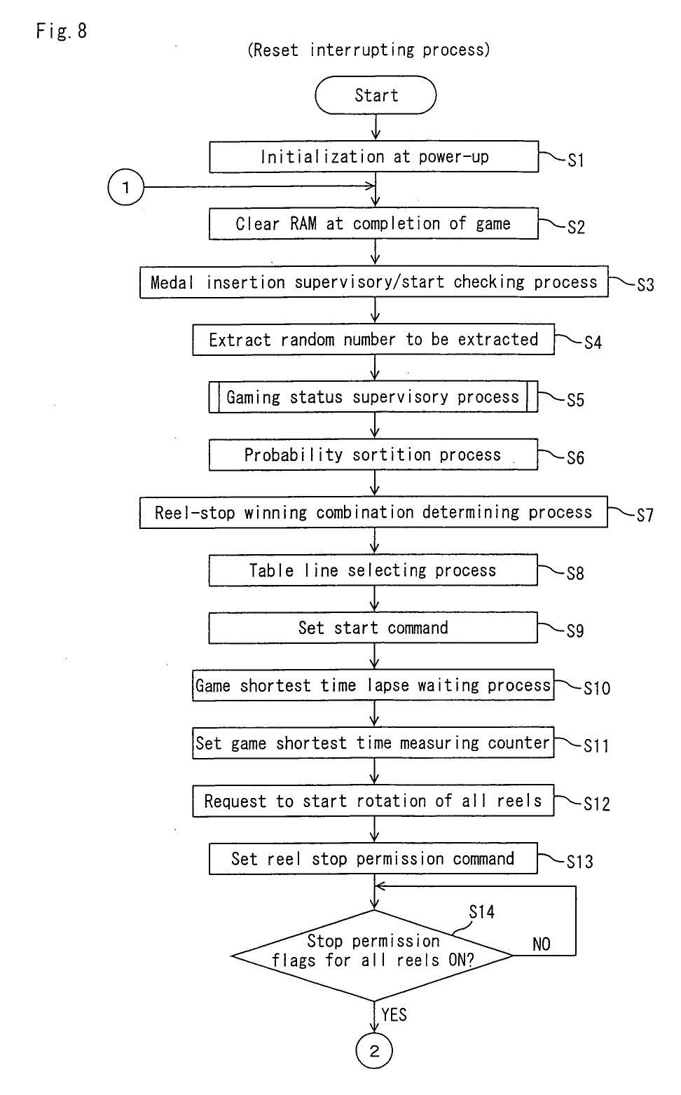

With reference to flowcharts shown in FIGS. 8 to 10, a RESET intervention process in the main control circuit 71 will be described.

First, the CPU 31 executes initialization at power-up (step S1). More specifically, the CPU 31 initializes the content of storage in the RAM 33 and also initializes communication data and the like. Then, it erases a predetermined content of storage in the RAM 33 which was stored at the time of the completion of games (step S2) and then the process proceeds to step S3. More specifically, it erases data in the writable area of the RAM 33 used for the previous game, writes parameters required for the next game in the writing area of the RAM 33 and specifies the starting address for a sequence program for the next game.

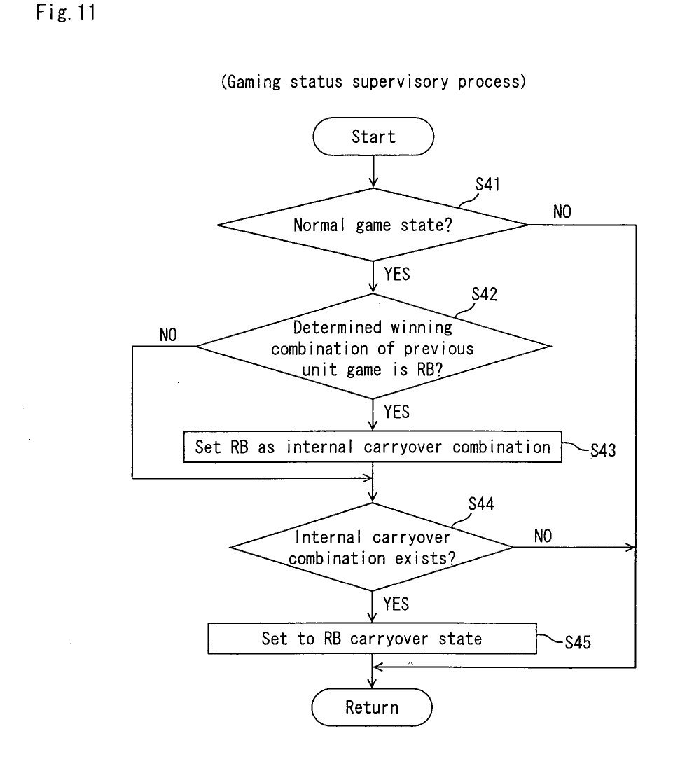

In step S3, a medal insertion supervisory/start checking process is conducted on the basis of input signals from the start switch 6S, the BET switches 11 to 13 and the medal sensor 22S and then the process proceeds to step S4. In step S4, a random number for lottery is extracted and then the process proceeds to step S5. In step S5, a gaming status supervisory process which will be described later with reference to FIG. 11 is conducted and then the process proceeds to step S6.

In step S6, a probability sortition process is conducted for determining an internal winning combination and then the process proceeds to step S7. In step S7, a reel-stop winning combination determining process is conducted for determining a winning combination for reel stop and then the process proceeds to step S8. The internal winning combination and the winning combination for reel stop are both included in winning combinations. The winning combination for reel stop is determined on the basis of the internal winning combination, and the states of reel stop control is defined for the respective winning combinations for reel stop.

In step S8, a table line selecting process is conducted and then the process proceeds to step S9. In step S9, a start command including information about an internal winning combination and the like is set and the process proceeds to step S10. In step S10, a game shortest time lapse waiting process is conducted and then the process proceeds to step S11. In step S11, a game shortest time measuring counter is set and the process proceeds to step S12.

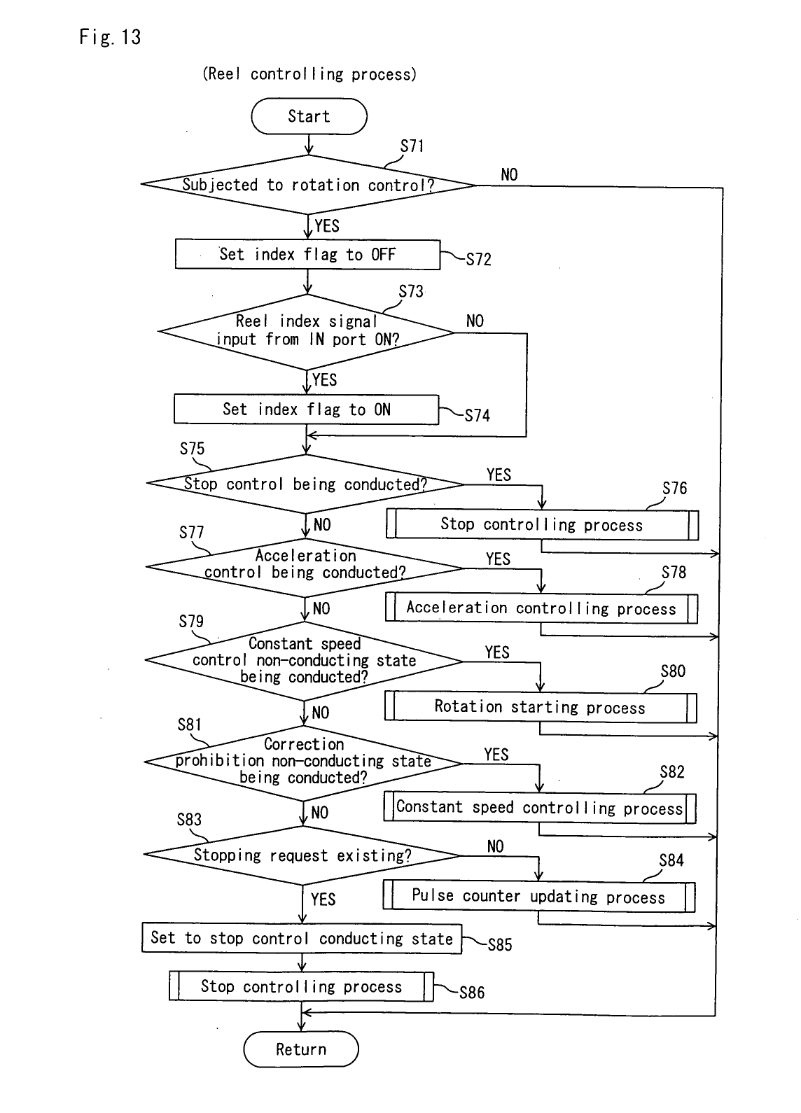

In step S12, an all-reel rotation starting request is generated and then the process proceeds to step S13. With the all-reel rotation starting request, the determination in step S71 in FIG. 13 which will be described later results in YES, thereby starting the acceleration control for the reels. In step S13, a reel stop permission command is set and the process proceeds to step S14.

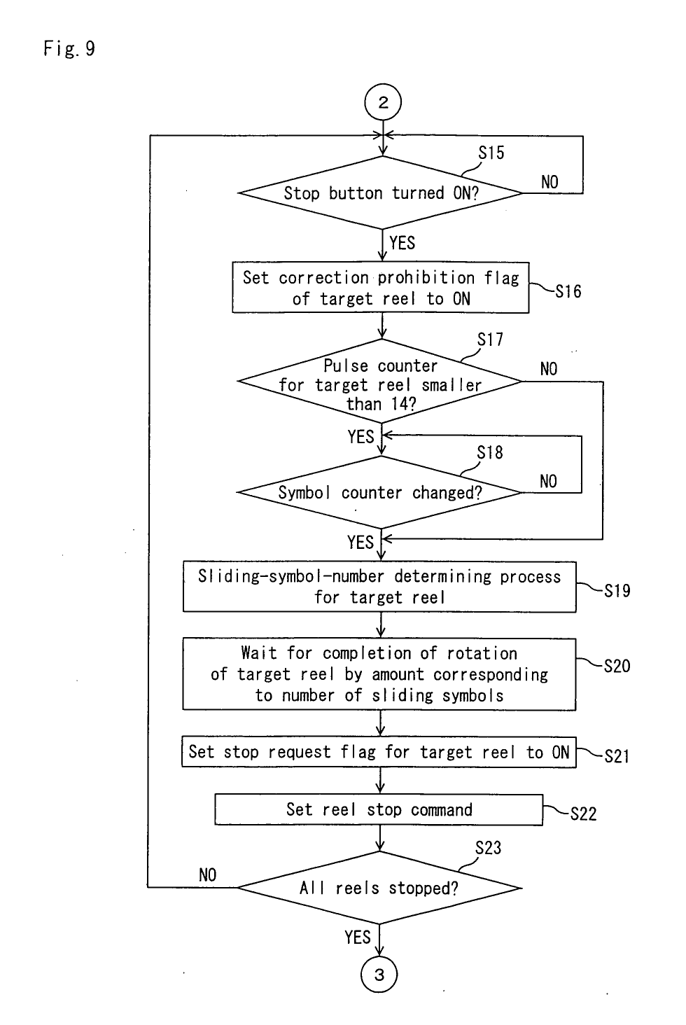

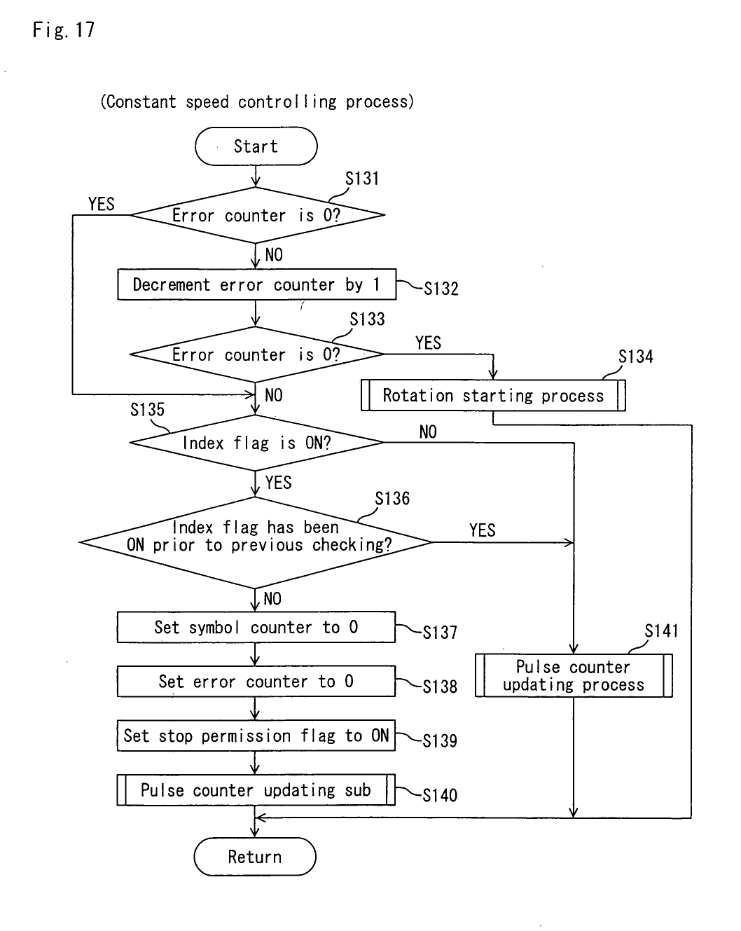

In step S14, it is determined whether or not stop permission flags for all the reels are ON. If this determination results in YES, the process proceeds to step S15 in FIG. 9. The reel stop permission flags are updated to ON, when indexes are detected at first in the constant speed control process (step S139 in FIG. 17 which will be described later). When the reel stop permission flags are ON, the operation of the stop buttons becomes effective.

In step S15 in FIG. 9, it is determined whether or not a stop button has been turned ON, namely whether or not there has been an input from the reel stop signal circuit 46. If this determination results in YES, a correction prohibition flag for the target reel is set to ON (step S16) and the process proceeds to step S17. The target reel is the reel corresponding to the operated stop button. The correction prohibition flag is information used for the determination in step S81 in FIG. 13 which will be described later.

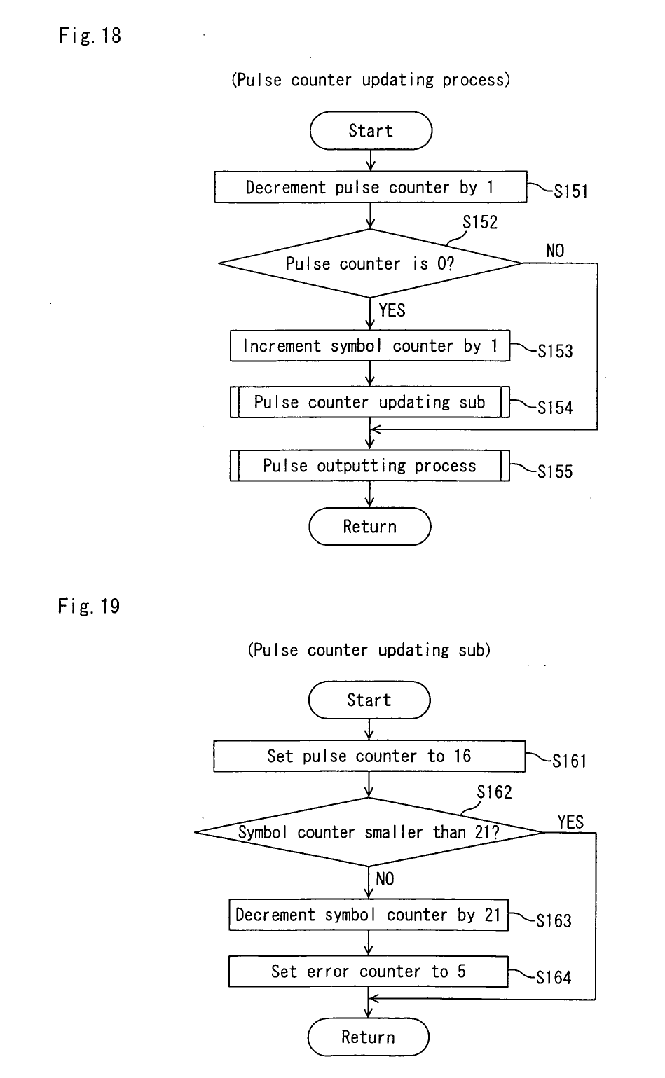

In step S17, it is determined whether or not the value of the pulse counter for the target reel is smaller than 14. If the determination results in YES, the process proceeds to step S18 and, if the determination results in NO, the process proceeds to step S19. The value of the pulse counter is information basically for identifying the rotational angle of the reel during the constant speed control and is decremented by one in a later-described step S151 in FIG. 18, when the pulse data is output.

In step S18, it is determined whether or not the symbol counter has been changed and, if the determination results in YES, the process proceeds to step S19. The value of the symbol counter is information for identifying the symbol position (rotational angle) and is incremented by one when the value of the pulse counter is updated to 0. The value of the pulse counter is varied within the range of 0 to 16.

In step S19, a sliding-symbol-number determining process is conducted for the target reel and then the process proceeds to step S20. In step S20, the completion of the rotation of the target reel by an amount corresponding to the number of sliding symbols is waited and then the process proceeds to step S21. In step S21, a stop request flag for the target reel is set to ON and the process proceeds to step S22. The stop request flag is information used for the determination in step S83 in FIG. 13, which will be described later.

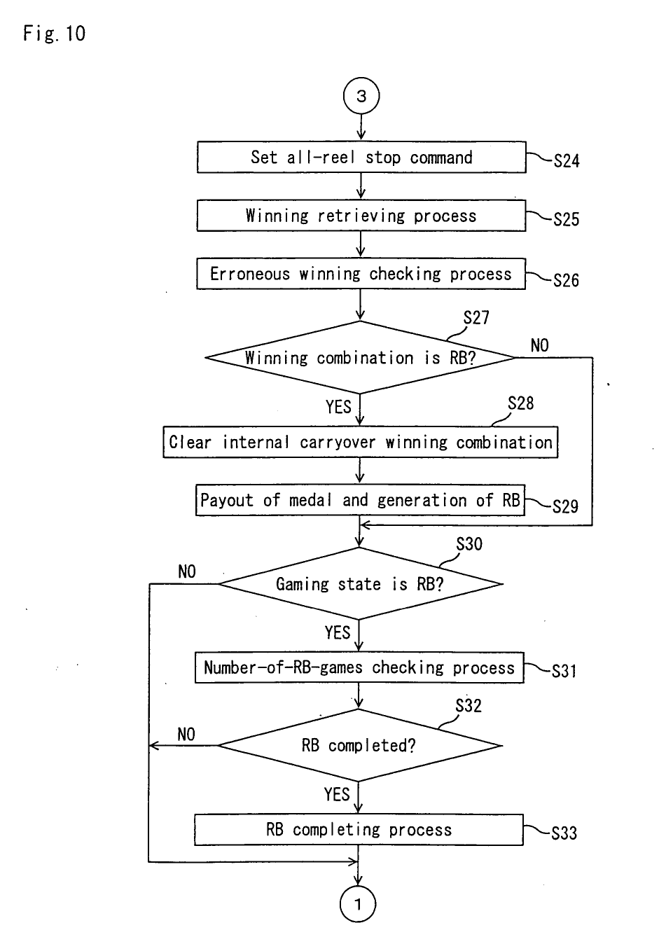

In step S22, a reel stop command is set and the process proceeds to step S23. In step S23, it is determined whether or not all the reels have been stopped. If the determination results in YES, the process proceeds to step S24 in FIG. 10 and, if the determination results in NO, the process proceeds to step S15.

In step S24 in FIG. 10, an all-reel stop command is set and the process proceeds to step S25. In step S25, winning retrieval is conducted and the process proceeds to step S26. In step S26, an erroneous winning checking process is conducted and the process proceeds to step S27. In step S27, it is determined whether or not the determined winning combination is a regular bonus (RB). If the determination results in YES, the process proceeds to step S28. If the determination results in NO, the process proceeds to step S30.

In step S28, the carried-over winning combination (internal carryover winning combination) is cleared and the process proceeds to step S29. In step S29, medals are paid out and an RB is generated and then the process proceeds to step S30. In step S30, it is determined whether or not the gaming state is an RB gaming state. If the determination results in YES, the process proceeds to step S31. If the determination results in NO, the process returns to step S2 in FIG. 8.

In step S31, a number-of-RB-games checking process is conducted and the process proceeds to step S32. In step S32, it is determined whether or not the RB has been completed. If the determination results in YES, the process proceeds to step S33. If the determination results in NO, the process returns to step S2 in FIG. 8. In step S33, an RB completing process is conducted and the process proceeds to step S2 in FIG. 8.

With reference to FIG. 11, a gaming status supervisory process will be described.

First, the CPU 31 determines whether or not the current gaming state is a normal gaming state (step S41). If the determination results in YES, the process proceeds to step S42. If the determination results in NO, the process returns to step S6 in FIG. 8. In step S42, it is determined whether or not the determined winning combination of the previous unit game (game) was an RB. If the determination results in YES, the process proceeds to step S43. If the determination results in NO, the process proceeds to step S44.

In step S43, an RB is set as an internal carryover winning combination and the process proceeds to step S44. In step S44, it is determined whether or not there is an internal carryover winning combination. If the determination results in YES, the process proceeds to step S45. If the determination results in NO, the process proceeds to step S6 in FIG. 8. In step S45, the gaming state is set to a carryover state, and the process proceeds to step S6 in FIG. 8

With reference to FIG. 12, a periodical intervention process in the main control circuit 71 will be described. The periodical intervention process is conducted at 1.1173-msec intervals.

First, the CPU 31 saves the register (step S51) and proceeds to step S52. In step S52, an input port checking process is conducted and the process proceeds to step S53. In step S53, a communication data transmitting process is conducted and the process proceeds to step S54. In step S54, an intervention counter is incremented by one and the process proceeds to step S55.

In step S55, it is determined whether or not the value of the intervention counter is an even number. If the determination results in YES, the process proceeds to step S56. If the determination results in NO, the process proceeds to step S57. In step S56, a 7-SEG drive controlling process is conducted and the process proceeds to step S63.

In step S57, information indicative of the right reel 3R is set as a reel identifier and the process proceeds to step S58. In step S58, a reel controlling process, which will be described later with reference to FIG. 13, is conducted and the process proceeds to step S59.

In step S59, information indicative of the center reel 3C is set as a reel identifier and the process proceeds to step S60. In step S60, the reel controlling process, which will be described later with reference to FIG. 13, is conducted and the process proceeds to step S61.

In step S61, information indicative of the left reel 3L is set as a reel identifier and the process proceeds to step S62. In step S62, the reel controlling process, which will be described later with reference to FIG. 13, is conducted and the process proceeds to step S63.

The reel controlling process illustrated in step S58, step S60 and step S62 is conducted when the value of the intervention counter is updated to an odd number, and the value of the intervention counter is updated at 1.1173-msec intervals. Therefore, the reel controlling process is conducted at 2.2346-msec intervals.

In step S63, a various-counter subtracting process is conducted and the process proceeds to step S64. In step S64, an electromagnetic counter controlling process is conducted and the process proceeds to step S65. In step S65, the register is restored and the periodic intervention process is completed.

With reference to FIG. 13, the reel controlling process will be described.

First, the CPU 31 refers to the reel identifier set in step S57, step S59 or step S61 before calling up the reel controlling process to determine whether or not the concerned reel is being subjected to rotation control (step S71). If the determination results in YES, the process proceeds to step S72. If the determination results in NO, the process proceeds to step S59, step S61 or step S63 in FIG. 12.

If the concerned reel is being subjected to the rotation control, this means that the reel is being subjected to one of the stop control, the acceleration control and the constant speed control. For example, if the value at the region of the stop control conducting state flag provided in the RAM 33 is ON, it is determined that the target reel is being subjected to the stop control and, therefore, being subjected to the rotation control. If the value is OFF, it is determined that the target reel is not being subjected to the stop control and, therefore, is not being subjected to the rotation control. This is similarly applied to the cases of the acceleration control conducting state and the constant speed control conducting state.

Further, in the reel controlling process, reference is made to the reel identifier set in step S57, step S59 or step S61 before this process is called up, and then a process suitable for the state of the concerned reel is conducted. For example, in the case where the right reel 3R is controlled, information indicative of the right reel 3R is set as a reel identifier in step S58 and, during the reel controlling process conducted subsequently to step S58, reference is made to information relating to the right reel 3R such as the stop control conducting state flag, the acceleration control conducting state flag and the constant speed control conducting state flag while setting of such information is performed. Further, during the reel controlling process, reception of signals and outputting of excitation signals relating to the right reel 3R are performed. Further, in the case of the left reel 3L and the center reel 3C, similarly, reference is made to information about the concerned reel while setting of such information is performed.

In step S72, an index flag is set to OFF and then the process proceeds to step S73. In step S73, it is determined whether or not a reel index signal input from the IN port is ON. If the determination results in YES, the process proceeds to step S74. If the determination results in NO, the process proceeds to step S75.

In step S74, the index flag is set to ON and then the process proceeds to step S75. The index flag is information for identifying whether or not an index has been detected (whether or not a reset pulse has been obtained). When an index has been detected, the index flag is ON.

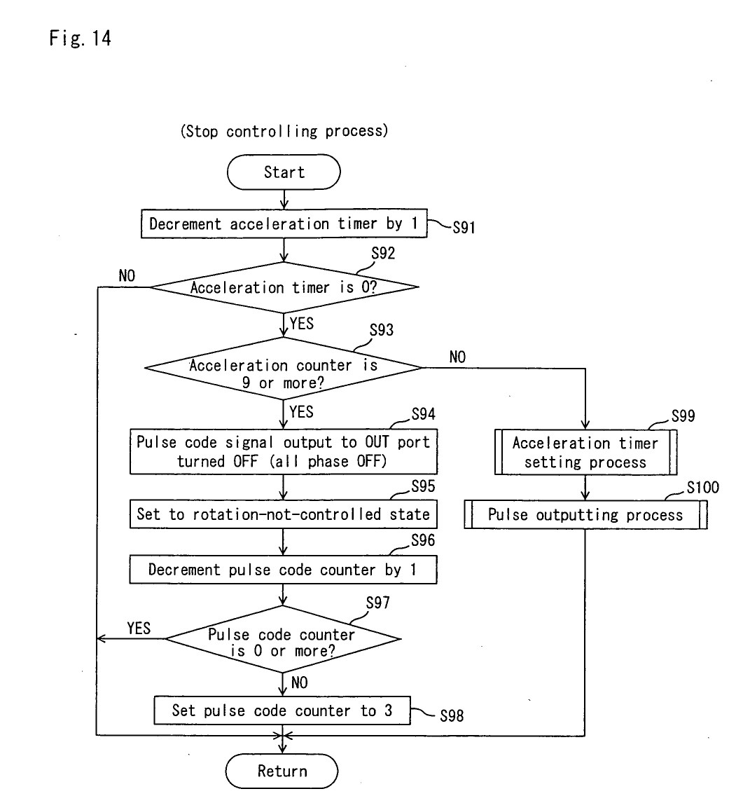

In step S75, it is determined whether or not the stop control is being conducted. If the determination results in YES, the process proceeds to step S76. If the determination results in NO, the process proceeds to step S77. The setting to the stop control conducting state is performed in step S85 which will be described later. In step S76, the stop controlling process, which will be described later with reference to FIG. 14, is conducted and then the process proceeds to step S59, step S61 or step S63 in FIG. 12.

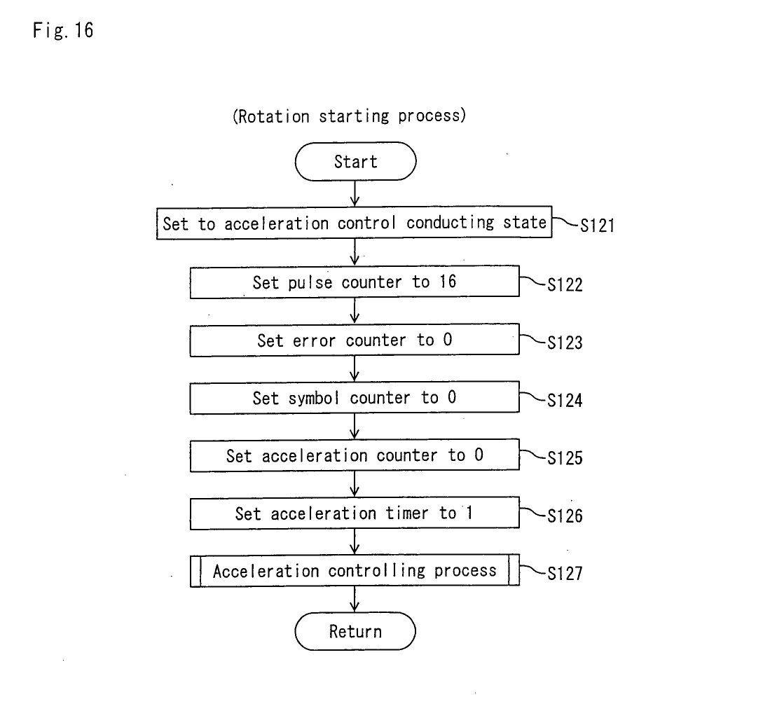

In step S77, it is determined whether or not the acceleration control is being conducted. If the determination results in YES, the process proceeds to step S78. If the determination results in NO, the process proceeds to step S79. The setting to the acceleration control conducting state is performed in step S121 in FIG. 16 which will be described later. In step S78, the acceleration controlling process, which will be described later with reference to FIG. 15, is conducted and then the process proceeds to step S59, step S61 or step S63 in FIG. 12.

In step S79, it is determined whether or not the constant speed control non-conducting state is being conducted. If the determination results in YES (the constant speed control not being conducted), the process proceeds to step S80. If the determination results in NO (the constant speed control being conducted), the process proceeds to step S81. The setting to the constant speed control conducting state is performed in step S115 in FIG. 15 which will be described later. In step S80, a rotation starting process, which will be described later with reference to FIG. 16, is conducted and then the process proceeds to step S59, step S61 or step S63 in FIG. 12.

In step S81, it is determined whether or not the correction prohibition non-conducting state is being conducted (whether or not the correction prohibition flag is ON). If the determination results in YES (the correction prohibition flag not turned ON), the process proceeds to step S82. If the determination results in NO (the correction prohibition flag turned ON), the process proceeds to step S83. In step S82, a constant speed controlling process, which will be described later with reference to FIG. 17, is conducted and then the process proceeds to step S59, step S61 or step S63 in FIG. 12.

In step S83, it is determined whether or not there is a stop request (whether or not the stop request flag is ON). If the determination results in YES, the process proceeds to step S85. If the determination results in NO, the process proceeds to step S84. In step S84, a pulse counter updating process, which will be described later with reference to FIG. 18, is conducted and then the process proceeds to step S59, step S61 or step S63 in FIG. 12.

In step S85, setting to the stop control conducting state is performed. For example, the regions of the constant speed control conducting state flag and a stop request flag provided in the RAM 33 are set to OFF while the region of the stop control conducting state flag provided in the RAM 33 is set to ON (in the cases of setting to the acceleration control conducting state and the constant speed control conducting state, the corresponding flags may be configured to be set similarly). Thereafter, the process proceeds to step S86. In step S86, a stop controlling process, which will be described later with reference to FIG. 14, is conducted and then the process proceeds to step S59, step S61 or step S63 in FIG. 12.

With reference to FIG. 14, the stop controlling process will be described.

First, the CPU 31 decrements the value of the acceleration timer by one (step S91) and the process proceeds to step S92. In step S92, it is determined whether or not the value of the acceleration timer is 0. If the determination results in YES, the process proceeds to step S93. If the determination results in NO, the process proceeds to step S59, step S61 or step S63 in FIG. 12.

In step S93, it is determined whether or not the value of the acceleration counter is 9 or more. If the determination results in YES, the process proceeds to step S94. If the determination results in NO, the process proceeds to step S99. In step S94, the pulse code signal which has been output to the OUT port is turned OFF (all phase OFF) and then the process proceeds to step S95. In step S95, setting to rotation-not-controlled state is performed (for example, the region of the stop control flag in the RAM 33 is set to OFF and, as a matter of course, the flags for stop control conducting state, acceleration control conducting state and constant speed control conducting state may be all set to OFF) and then the process proceeds to step S96.

In step S96, the value of the pulse code counter is decremented by one and then the process proceeds to step S97. In step S97, it is determined whether or not the value of the pulse code counter is 0 or more. If the determination results in YES, the process proceeds to step S59, step S61 or step S63 in FIG. 12. If the determination results in NO, the process proceeds to step S98. In step S98, the value of the pulse code counter is set to 3 and then the process proceeds to step S59, step S61 or step S63 in FIG. 12.

In step S99, an acceleration timer setting process, which will be described later with reference to FIG. 21, is conducted and then the process proceeds to step S100. In step S100, a pulse outputting process, which will be described later with reference to FIG. 20, is conducted and then the process proceeds to step S59, step S61 or step S63 in FIG. 12.

With reference to FIG. 15, an acceleration controlling process will be described.

First, the CPU 31 decrements the value of the acceleration timer by one (step S111) and then the process proceeds to step S112. In step S112, it is determined whether or not the value of the acceleration timer is 0. If the determination results in YES, the process proceeds to step S113. If the determination results in NO, the process proceeds to step S59, step S61 or step S63 in FIG. 12.

In step S113, an acceleration timer setting process which will be described later with reference to FIG. 21 is conducted and then the process proceeds to step S114. In step S114, it is determined whether or not the value of the acceleration counter is smaller than 5. If the determination results in YES, the process proceeds to step S116. If the determination results in NO, the process proceeds to step S115. In step S115, setting to the constant speed control conducting state is performed (for example, the region of the acceleration control flag in the RAM 33 may be set to OFF and the region of the constant speed control flag in the RAM 33 may be set to ON) and then the process proceeds to step S116. In step S116, a pulse outputting process which will be described later with reference to FIG. 20 is conducted and then the process proceeds to step S59, step S61 or step S63 in FIG. 12.

With reference to FIG. 16, the rotation starting process will be described.

First, the CPU 31 sets the acceleration control conducting state (for example, the region of the acceleration control flag in the RAM 33 may be set to ON) (step S121) and the process proceeds to step S122. In step S122, the pulse counter is set to 16 and then the process proceeds to step S123. In step S123, the error counter is set to 0 and then the process proceeds to step S124.

In step S124, the symbol counter is set to 0 and then the process proceeds to step S125. In step S125, the acceleration counter is set to 0 and then the process proceeds to step S126. In step S126, the acceleration timer is set to 1 and then the process proceeds to step S127. In step S127, the acceleration controlling process illustrated in FIG. 15 is conducted and then the process proceeds to step S59, step S61 or step S63 in FIG. 12.

With reference to FIG. 17, the constant speed controlling process will be described.

First, the CPU 31 determines whether or not the value of the error counter is 0 (step S131). If the determination results in YES, the process proceeds to step S135. If the determination results in NO, the process proceeds to step S132. In step S132, the value of the error counter is decremented by one and then the process proceeds to step S133.

In step S133, it is determined whether or not the value of the error counter is 0. If the determination results in YES, the process proceeds to step S134. If the determination results in NO, the process proceeds to step S135. In step S134, the rotation starting process illustrated in FIG. 16 is conducted and then the process proceeds to step S59, step S61 or step S63 in FIG. 12.

Namely, the error counter is set to a value other than 0 (for example, it is set in step S164 which will be described later) and then is proceeded to countdown at every other intervention and then the process proceeds to the rotation starting process in step S134 at the timing of intervention which changes the value of the error counter from 1 to 0. Namely, after a single rotation of the reel, which is recognized when the after-mentioned symbol counter and the pulse counter are updated, if no reel index is detected until the excitation position of the stepping motor has been changed five times, more specifically, if the determining process in step S135 which will be described later results in YES, and the determining process in step S136 which will be described later does not result in NO, it is determined that the reel is at an error state where the reel is not rotated a single time at a constant speed of 80 rpm. Then, the rotation starting process step S134 is conducted so that the reel is reactivated (reaccelerated) from the stop state.

In step S135, it is determined whether or not the index flag is ON, wherein the index flag is set to OFF or ON in step S72 or step S74. If the determination results in YES, the process proceeds to step S136. If the determination results in NO, the process proceeds to step S141. In step S136, it is determined whether or not the index flag has been ON prior to the previous checking. If the determination results in YES, the process proceeds to step S141. If the determination results in NO (if the index is detected in the current process), the process proceeds to step S137.

More specifically, since the reel controlling process is called up for controlling the right reel 3L, the center reel 3C and the left reel 3R at every other intervention, if it is determined that the reel index signal is OFF from the determining process in step S73 in the reel controlling process called up from the second last intervention process and also if it is determined that the reel index signal is ON from the determining process in step S73 in the reel controlling process called up from the current intervention process, this means the reel has been rotated a single time at a constant speed of 80 rpm and the process proceeds to step S137. Otherwise, the process proceeds to step S141.

In step S137, the symbol counter is set to 0 and the process proceeds to step S138. In step S138, the error counter is set to 0 and then the process proceeds to step S139. In step S139, the stop permission flag is set to ON and then the process proceeds to step S140. In step S140, a pulse counter updating sub which will be described later with reference to FIG. 19 is conducted and then the process proceeds to step S59, step S61 or step S63 in FIG. 12. In step S141, a pulse counter updating process which will be described later with reference to FIG. 18 is conducted and then the process proceeds to step S59, step S61 or step S63 in FIG. 12.

With reference to FIG. 18, the pulse counter updating process will be described. This process is conducted at the timing of step S84 in FIG. 13 and step S141 in FIG. 17.

First, the CPU 31 decrements the value of the pulse counter by one (step S151) and then proceeds to step S152. In step S152, it is determined whether or not the value of the pulse counter is 0. If the determination results in YES (namely, it is determined that the excitation position has been changed the times corresponding to a single symbol), the process proceeds to step S153. If the determination results in NO, the process proceeds to step S155.

In step S153, the symbol counter is incremented by one and then the process proceeds to step S154. In step S154, a pulse counter updating sub which will be described later with reference to FIG. 19 is conducted and then the process proceeds to step S155. In step S155, a pulse outputting process which will be described later with reference to FIG. 20 is conducted and then the process proceeds to step S59, step S61 or step S63 in FIG. 12.

With reference to FIG. 19, the pulse counter updating sub will be described. This process is conducted at the timings of step S140 in FIG. 17 and step S154 in FIG. 18.

First, the CPU 31 sets the pulse counter to 16 (step S161) and the process proceeds to step S162. In step S162, it is determined whether or not the value of the symbol counter is smaller than 21. If the determination results in YES, the process proceeds to step S59, step S61 or step S63 in FIG. 12, or step S155 in FIG. 18.

If the determination in step S162 results in NO, the value of the symbol counter is decremented by 21 (for setting it to 0) (step S163) and then the process proceeds to step S164. In step S164, the error counter is set to 5 and then the process proceeds to step S59, step S61 or step S63 in FIG. 12, or step S155 in FIG. 18.

With reference to FIG. 20, the pulse outputting process will be described. This process is conducted at the timings of step S100 in FIG. 14, step S116 in FIG. 15 and step S155 in FIG. 18.

First, the CPU 31 increments the value of the pulse code counter by one (step S171) and the process proceeds to step S172. In step S172, it is determined whether or not the value of the pulse code counter is greater than 3. If the determination results in YES, the process proceeds to step S173. If the determination results in NO, the process proceeds to step S174. In step S173, the pulse code counter is set to 0 and then the process proceeds to step S174.

In step S174, on the basis of the pulse data table (FIG. 7A) and the value of the pulse code counter, pulse data is acquired and then the process proceeds to step S175. In step S175, it is determined whether or not the value of the acceleration counter is 9. If the determination results in YES (after the completion of 12 interventions for the control for reducing the speed to 40 rpm (the deceleration control based on the acceleration counter values of 5, 6 and 7)), the process proceeds to step S176. If the determination results in NO, the process proceeds to step S177.

In step S176, the bit 4 of the pulse data is set to ON (the chopping output bit is set to ON) in order to complete the chopping electric current control for the stepping motors by the next reel activation. Then, the process proceeds to step S177. In step S177, the pulse data is output from the OUT port and then the process proceeds to step S59, step S61, or step S63 in FIG. 12.

With reference to FIG. 21, the acceleration timer setting process will be described. This process is conducted at the timings of step S99 in FIG. 14 and step S113 in FIG. 15.

First, the CPU 31 acquires the value of the acceleration timer, on the basis of the acceleration table (FIG. 7B) and the value of the acceleration counter (step S181) and then the process proceeds to step S182. In step S182, the value of the acceleration counter is incremented by one and then the process proceeds to step S100 in FIG. 14 or step S114 in FIG. 15.

While an embodiment has been described hereinbefore, the present invention is not limited to this embodiment.

For example, the motor driving circuit 39 may be designed as a control LSI. There are exemplary LSI designs as follows; (1) three-axes controls can be performed (a three-axes concurrent starting function, an independent stopping function), (2) acceleration, constant speed and deceleration operations through external inputs or CPU commands, (3) a position information reading function (output pulses can be internally counted and read by the CPU), (4) a two-phase stepping motor excitation distribution function (unipolar, bipolar), (5) acceleration, deceleration and the rotation speed and the like are programmable.

Such an LSI may be mounted to the gaming machine to enable controlling the reel motors. There is an exemplary processing flow as follows. When the CPU 31 generates an activation command, the LSI activates the three axes at the same time and generates a stop permission signal after a constant speed rotation is attained. The CPU 31 receives operations on the stop buttons 7L, 7C and 7R, reads position information, determines the stopping positions and then generates a stopping position specification command. Then, the LSI conducts deceleration/stop control.

As described above, the gaming machine 1 according to the embodiment is a gaming machine having the following configuration.

(1) A gaming machine comprising: game start command means (for example, the start switch 6S) for outputting a game start command signal for commanding the start of an unit game (for example, a single game), in accordance with a player's operations (for example, the operation on the start lever 6); reel rotation start control means (for example, the motor driving circuit 39) for starting the rotations of plural reels on the basis of the detection of the game start command signal; winning combination determination means (for example, the main control circuit 71) for determining a winning combination (for example, an internal winning combination) from predetermined winning combinations (for example, bonuses, minor winning combinations, replays) based on the detection of the game start command signal; stop command means (for example, the reel stop signal circuit 46) for outputting a stop command signal in accordance with player's operations (for example, operations on the stop buttons 7L, 7C and 7R); reel stop control means (for example, the main control circuit 71, the reel stop signal circuit 46) for stopping the rotations of the reels based on the detection of the stop command signal and on the determined winning combination; and game value provision means (for example, the main control circuit 71, the hopper 40) for providing a predetermined game value (for example, a predetermined number of medals) to the player when the plural reels are stopped by the stop command means at a predetermined manner (for example, a state indicative of winning, symbol stop states corresponding to winning combinations), wherein the reel rotation start control means (for example, the motor driving circuit 39) and the winning combination determination means (for example, the main control circuit 71) have different control means.

With the gaming machine described in (1), for example, it may be possible to realize load reduction of CPU and the main control circuit 71 whose functions are regulated by law while providing a gaming machine which gives high zest to the game.

Also, the present invention may be applied to other gaming machines other than pachinko gaming machines, as well as the gaming machine 1 according to the present embodiment.

What is claimed as new and desired to be secured by Letters Patent of the United States is:

1. A gaming machine comprising:
game start command means for outputting a game start command signal for commanding the start of an unit game in accordance with player's operations;
reel rotation start control means for starting the rotation of plural reels based on the detection of said game start command signal;
winning combination determination means for determining a winning combination from predetermined winning combinations based on the detection of said game start command signal;
stop command means for outputting a stop command signal in accordance with player's operations;
reel stop control means for stopping the rotation of said reels based on the detection of said stop command signal and on the determined winning combination; and
game value provision means for providing a predetermined game value to the player when said plural reels are stopped in a predetermined manner by said stop control means,
wherein
said reel rotation start control means and said winning combination determination means have different control means.
